(19) United States
(12) Patent Application Publication
(10) Pub. No.: US 2016/0335209 A1
(43) Pub. Date: Nov. 17, 2016

(54) HIGH-SPEED DATA TRANSMISSION USING PCIE PROTOCOL

(71) Applicant: Quanta Computer Inc., Taoyuan City (TW)

(72) Inventors: Maw-Zan JAU, Taoyuan City (TW); Ching-Chih SHIH, Taoyuan City (TW)

(21) Appl. No.: 14/708,921

(22) Filed: May 11, 2015

(51) Int. Cl. G06F 13/36; G06F 13/42; G06F 13/40

(52) U.S. Cl. CPC G06F 13/36; G06F 13/4068; G06F 13/4282

(57) ABSTRACT

Embodiments generally relate to data transmission in a computing system. The present technology discloses techniques that that can enable a high-bandwidth and low-latency data transmission using PCIe (Peripheral Component Interconnect Express) technology. According to some embodiments, by utilizing the PCIe protocol, the present technology can achieve high-speed data transmission for intra-rack network trafficking.

### FIELD OF THE INVENTION

The disclosure relates generally to data transmission in a computing system.

### BACKGROUND

With the growing popularity of Internet services and cloud computing, companies and individuals are becoming more reliant on information technology. To handle this massive computing demand, large-scale data centers are becoming more powerful and efficient. A data center typically includes a large group of networked servers or nodes for remote storage, processing or distribution of large amounts of data. For example, a data center can comprise a large number of rack units each housing numerous nodes. These nodes can transmit data through layers of network interfaces and protocols.

As the backbone of data transmission, network design is an important aspect of data center topology. Particularly, high-speed data transmission protocols are preferred for optimized network efficiency.

### SUMMARY

Aspects of the present technology disclose techniques that enable high-bandwidth and low-latency data transmission using Peripheral Component Interconnect Express (PCIe) technology. By decoupling Ethernet Network Interface Controllers (NICs) from one or more nodes in various embodiments, the present technology can achieve data transmission efficiency for intra-rack data transmission.

According to some embodiments, the present technology can provide high-speed networking by using PCIe for intra-rack data transmission. According to some embodiments, the present technology can couple an Ethernet NIC with a PCIe device that is physically separated from a switch device, eliminating any inflexibility caused by embedding the NICs into the silicon of a switch device.

According to some embodiments, each node within a rack has a dedicated Ethernet NIC associated with it. A NIC can implement a network interface, e.g., LAN, for data transmission between network devices. For example, according to Ethernet protocol, an Ethernet NIC can transmit data from a source node to a destination node by identifying a source IP (Internet Protocol) and a destination IP in a packet header.

According to some embodiments, a node can be dynamically assigned an Ethernet NIC from a pool of NICs based on a networking load associated with the node. According to some embodiments, a node can be assigned other peripheral devices, e.g. storage cards, based on the storage assignment of the node.

According to some embodiments, the present technology can utilize a PCIe switch to provide flexible and dynamic network management. For example, a PCIe switch can assign one or more NICs to a node A. A PCIe switch can re-assign a NIC from node A to a node B. Further, a PCIe switch can manage other PCIe devices such as a Non-Volatile Memory Express (NVMe) controller, or a storage device. Additionally, other I/O expansion technology switches can be utilized for providing the dynamic network management.

According to some embodiments, a service controller, e.g. Baseboard Management Controller (BMC), can communicate with a PCIe switch for configuration. BMC is an independent and embedded microcontroller that, in some embodiments, is responsible for the management and monitoring of the main CPU and peripheral devices on the motherboard. According to some embodiments, BMC can provide local network interface (LAN) access to the PCIe switch via a dedicated interface implemented by a NIC of the BMC. Additionally, other service controller, such as a Rack Management Controller (RMC), can manage the PCIe switch as well as devices in communication with the switch.

Although many of the examples herein are described with reference to utilizing the high-speed data transmission capacity of PCIe, it should be understood that these are only examples and the present technology is not limited in this regard. Rather, any I/O expansion bus technology may be used.

Additionally, even though the present disclosure uses a PCIe switch as an example approach of how to dynamically assign NICs, the present technology is applicable to other switch devices that can handle high-speed data transmission and provide switching functions.

Additional features and advantages of the disclosure will be set forth in the description which follows, and, in part, will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

Various embodiments or examples (“examples”) of the invention are disclosed in the following detailed description and the accompanying drawings:

FIG. 1 illustrates an overall system diagram including server racks and switches, according to some embodiments;

FIG. 2 is a schematic block diagram illustrating an example of a PCIe high-bandwidth rack system with dedicated NICs, according to some embodiments;

FIG. 3 is another schematic block diagram illustrating an example of a PCIe high-bandwidth rack system with dynamic NICs, according to some embodiments;

FIG. 4 is a schematic block diagram illustrating an example of a PCIe switch, according to some embodiments;

FIG. 5 is an example flow diagram for a PCIe high-bandwidth rack system, according to some embodiments;

FIG. 6 is another example flow diagram for a PCIe high-bandwidth rack system having a PCIe switch, according to some embodiments; and

FIG. 7 illustrates a computing platform of a computing device, according to some embodiments.

### DETAILED DESCRIPTION

Various embodiments of the present technology are discussed in detail below. While specific implementations are discussed, it should be understood that this is done for illustration purposes only. A person skilled in the relevant art will recognize that other components and configurations may be used without departing from the spirit and scope of the present technology.

To meet growing computing demand, a computing system demands high-bandwidth and low-latency data transmission. In modern data center topology design, switches are built into the backplane of a rack unit to inter-connect different nodes. These built-in switches, called switch fabrics, can reduce the complexity of network cabling because they directly connect nodes with copper or fiber. For example, a Top-of-Rack (TOR) switch can route data internal or external to a rack. Another type of built-in switch is an integrated switch embedded in the middle of a rack unit that can communicate with other network devices.

Traditionally, built-in switches use an Ethernet interface for signal routing. Ethernet is a widely-adopted local area network (LAN) technology specified in IEEE 802.3. Ethernet is reliable and offers high-throughput capacity. For example, 1 Gigabit or 10 Gigabit Ethernet signals define Ethernet frames at a rate of 1 or 10 gigabits per second.

However, compared with other high bandwidth system interfaces within a rack unit, an Ethernet interface may have lower bandwidth and higher latency. Consequently, Ethernet interfaces or NICs can be a bottleneck in high-speed data transmission.

One approach is to remove the Ethernet NIC from a node and embed the NIC into the silicon of a switch, such as a die. But an embedded NIC is not easy to upgrade or change as technology advances. For example, when a new NIC technology becomes available, e.g. Remote Direct Memory Access, an administrator needs to change a switch device to keep up with the new NIC technology. Additionally, it can be difficult to replace an embedded NIC when it fails. As such, the embedded NIC can cause inflexibility in network management.

Thus, there is a need to provide a high-bandwidth and low-latency data transmission interface without losing the flexibility for NIC replacement or upgrade.

PCIe is a high-speed serial computer I/O (Input/Output) bus standard for connecting motherboard-mounted peripheral devices. By utilizing point-to-point serial lines instead of a shared parallel bus architecture, a PCIe link is able to provide high-bandwidth and low-latency data transmission, e.g. over 30 GB/s, for a 16-lane slot in each direction. Additionally, a connection between two PCIe devices is a PCIe link that can comprises one or more lanes.

According to some embodiments, the present technology can enable high-bandwidth and low-latency data transmission for interconnected nodes within a rack by providing PCIe data transmission between interconnected nodes. Particularly, aspects of the present technology can improve the functioning of a server by, for example, allowing for physically detaching an Ethernet NIC from a node it is associated with, and coupling the NIC with a PCIe device. Because the PCIe device is physically separated from a switch device, e.g. a TOR switch, it can eliminate the inflexibility caused by embedding NICs in a switch device. Further, aspects of the present technology are specific to the problems created by lower bandwidth network protocol, e.g. Ethernet, in a rack server system.

In addition to PCIe, the present technology can utilize other high-throughput computer I/O (Input/Output) expansion technologies for enabling high-bandwidth and low-latency data transmission for intra-rack data transmission.

According to some embodiments, a node within a rack can be assigned a dedicated Ethernet NIC. A NIC can implement a network interface, e.g., LAN, for data transmission between network devices. For example, according to Ethernet protocol, an Ethernet NIC can transmit data from a source node to a destination node by identifying a source IP and a destination IP in a packet header.

According to some embodiments, a node can be dynamically assigned an Ethernet NIC from a pool of NICs based on the networking load of the node. For example, node A can host a web application that handles large data transmission at peak hours from 9:00 a.m. to 5:00 p.m. To provide the necessary networking capacity, node A can be assigned two Ethernet NICs having two IP addresses at these peak time. Additionally, two or more nodes can share a NIC.

According to some embodiments, the present technology can utilize a PCIe switch to provide flexible and dynamic network management. For example, a PCIe switch can assign one or more NICs to node A, or change a NIC from node A to node B. Furthermore, a PCIe switch can manage other PCIe devices such as a Non-Volatile Memory Express (NVMe) controller or a storage card.

According to some embodiments, a service controller, e.g. Baseboard Management Controller (BMC), can communicate with a PCIe switch for configuration. BMC is an independent and embedded microcontroller that, in some embodiments, is responsible for the management and monitoring of the main CPU and other peripheral devices. BMC can communicate with other devices via Intelligent Platform Management Interface (IPMI) specification. The IPMI specification can define interfaces for hardware management. According to some embodiments, BMC can provide LAN access to the PCIe switch via a dedicated interface implemented by a NIC associated with the BMC. Further, a RMC in communication with the multiple BMCs can manage the PCIe switches within a rack unit by a dedicated interface implemented by a NIC associated with the RMC.

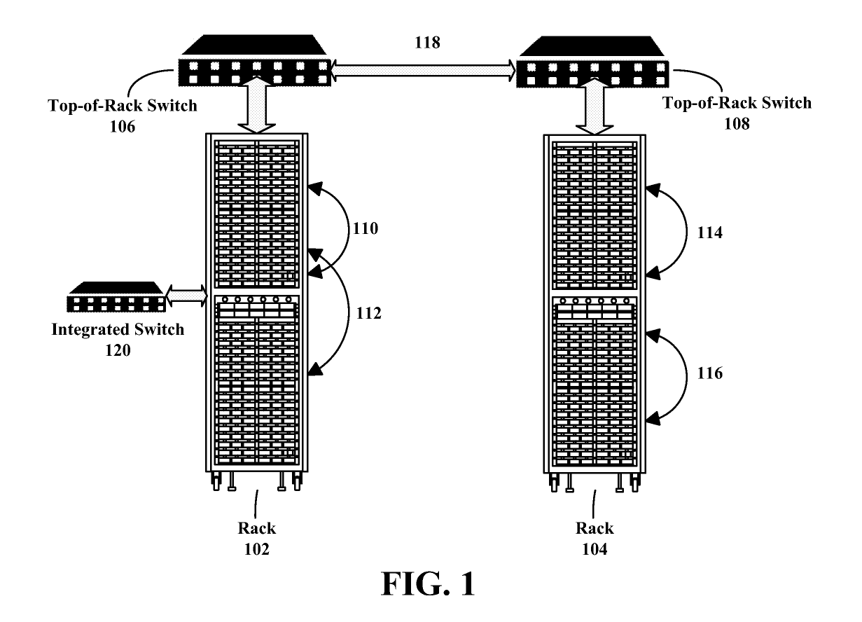

FIG. 1 illustrates an overall system diagram including server racks and switches, according to some embodiments. It should be appreciated that the topology in FIG. 1 is an example, and any numbers of racks, switches and network components may be included in the network of FIG. 1.

A network system can include a large number of racks that are connected by various network interfaces. For example, the system can include Rack 102 and Rack 104. Each of Rack 102 and Rack 104 can include a group of servers or nodes. These nodes can host different client applications, such as email or web applications. Further, these nodes can transmit data via layers of switch fabrics that are built into the rack's architecture. For example, TOR Switch 106 is usually housed at a top chassis of Rack 102. Using communication link 118, TOR Switch 106 can transmit data to another node in Rack 104 via TOR Switch 108.

According to some embodiments, communication link 118 can be based on Ethernet protocol specified by IEEE 802.3. Ethernet protocol defines wiring and signaling standards for the Open Systems Interconnection (OSI) model. It also defines packet format and Medium Access Control (MAC) format at the data link layer.

According to some embodiments, the present technology can enable PCIe data transmission for intra-rack network trafficking. As a standard for computer expansion cards, PCIe can connect peripheral devices to a computing device via a high-speed link. Usually, a connection between any two PCIe devices is known as a link, and can comprise one or more lanes. Because PCIe enables point-to-point serial links, it can provide advantages of high-speed data transmission over Ethernet transmission. For example, PCIe data transmission can reach over 30 GB/s for a 16-lane slot PCIe device. Additionally, other high-speed data transmission protocols can be used for intra-rack network trafficking according to embodiments of the present technology.

According to some embodiments, intra-rack data communications are transmitted via a high-speed PCIe backplane or bus. For example, data transmission between nodes within Rack 102, or data transmission between nodes within Rack 104. This can be achieved by decoupling the Ethernet NIC from its associated node and moving the NIC to a PCIe device (not shown). Further, the PCIe device is separated from Ethernet switches such as TOR Switch 106 or Integrated Switch 120. Thus, only network traffic that crosses different racks (e.g., Rack 102 to Rack 104) needs to go through Ethernet NICs that can cause transmission latency.

In addition to TOR Switch 106, Rack 102 can comprise an Integrated Switch 120 embedded, for example, in a node sled. Integrated Switch 120 can offer direct data routing to nodes in the sled. Additionally, Integrated Switch 120 can transmit data to TOR Switch 106 via Ethernet.

Additionally, multiple racks of a network system can be managed by a Rack Aggregation Switch (not shown) that can simplify the network for achieving Rack Scale Architecture (RSA).

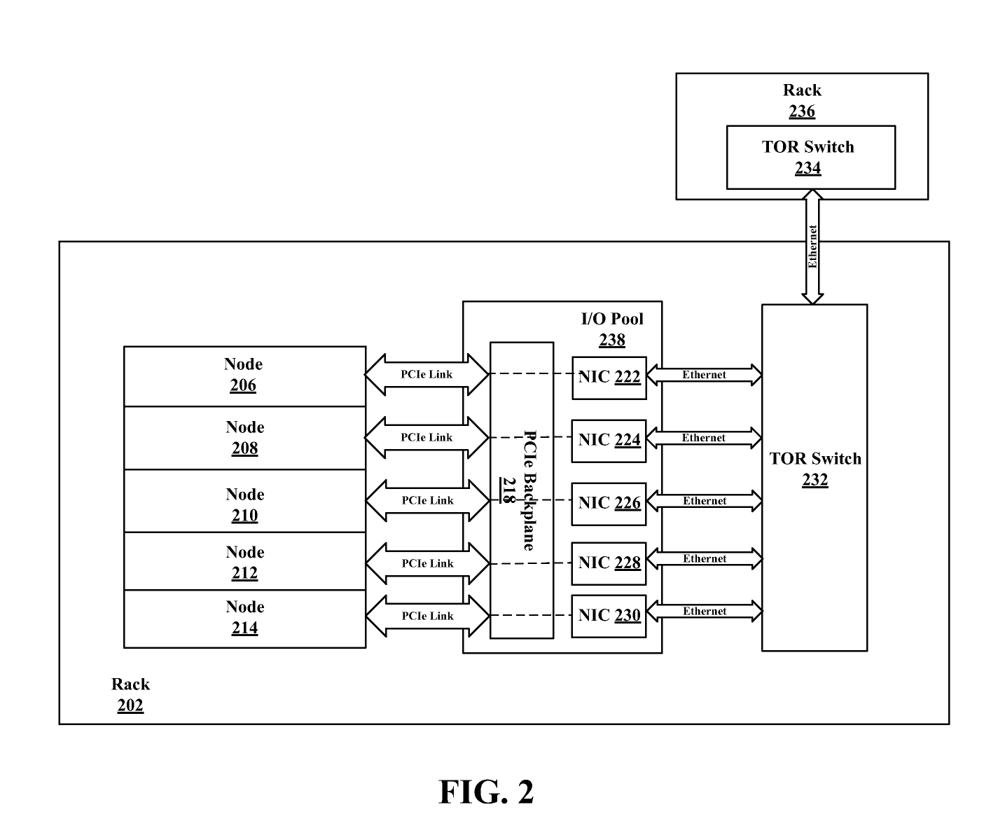

FIG. 2 is a schematic block diagram illustrating an example of a PCIe high-bandwidth rack system with dedicated NICs, according to some embodiments. Rack 202 can comprise a group of nodes, e.g. Node 206, 208, 210, 212, and 214 for various functions such as storage or computation. According to some embodiments, each node is associated with an Ethernet NIC for implementing a network interface, e.g. LAN, with another network device. As shown in FIG. 1, each of NICs 222, 224, 226, 228 and 230 is respectively dedicated to Node 206, 208, 210, 212, and 214. According to some embodiments, NICs 222-230 can be coupled to a PCIe device that serves as I/O Pool 238 between the nodes and TOR Switch 232.

According to some embodiments, a PCIe Backplane 218 can receive data from one of the nodes, determine a destination of the data, for example by identifying control commands in the data, and transmit the data via either a PCIe protocol or an Ethernet protocol. For example, PCIe Backplane 218 can receive data from Node 206 via a PCIe link. The data can be in PCIe signals. PCIe Backplane 218 can determine a destination for the data, e.g. by identifying a destination IP in a packet header.

When the destination of the data is another node within the same rack, the data communication is considered intra-rack and can take advantage of the point-to-point high-bandwidth protocols. For example, after determining that the data destination is Node 208, data can be transmitted to NIC 224 of Node 208, via PCIe Backplane 218.

Conversely, when the destination of the data is a node in another rack, the data communication is considered inter-rack and, in this example, it needs Ethernet transmission. For example, when data originating from Node 206 is determined to be sent to a node within Rack 236, the data is then transferred to TOR Switch 232 via Ethernet, which can transfer the data to TOR Switch 234 within Rack 236. According to some embodiments, Ethernet NIC 222 can convert the PCIe signals to Ethernet signals.

Alternatively, in addition to PCIe, other high-bandwidth interconnected protocols can be utilized for intra-rack data transmission. For example, InfiniBand can be used for intra-rack data transmission.

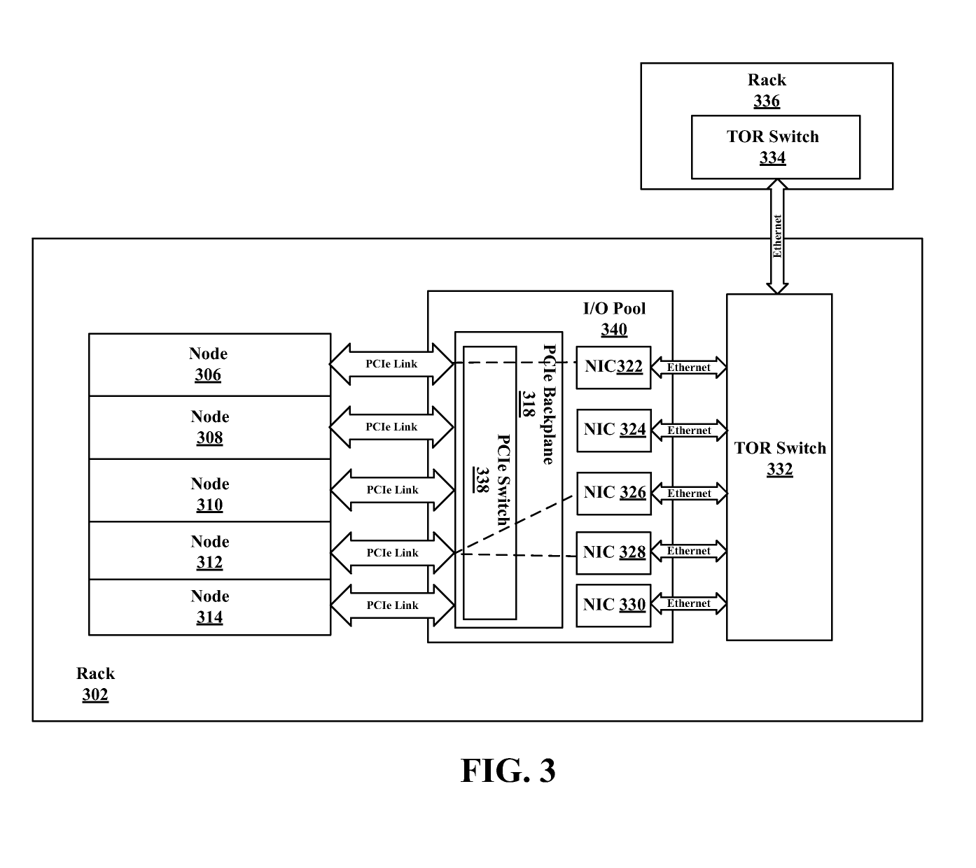

FIG. 3 is another schematic block diagram illustrating an example of a PCIe high-bandwidth rack system with dynamic NIC assignment, according to some embodiments. Rack 302 can comprises a group of nodes, e.g. Node 306, 308, 310, 312 and 314 for various functions such as storage or computation.

According to some embodiments, NICs 322, 324, 326, 328 and 330 are coupled to a PCIe Backplane 318, which is in communication with PCIe Switch 338 through I/O Pool 340. According to some embodiments, PCIe Switch 338 can dynamically assign any of NICs 322, 324, 326, 328 and 330 to any of Nodes 306, 308, 312 and 314 via PCIe Links, depending on the data transmission need of the system.

According to some embodiments, PCIe backplane 318 can receive data from one of the nodes, e.g. Node 306, and determine a destination of data, for example, by identifying a destination IP address in the header. When the destination of the data is another node, e.g. Node 310, the data communication is intra-rack. Accordingly, the intra-rack data traffic can be transferred through PCIe Link by PCIe Backplane 318. When the destination of the data is a node external to Rack 302, the data communication is considered inter-rack. Accordingly, the inter-rack data trafficking can be transferred by Ethernet protocol.

For example, when data originating from Node 306 is to be sent to a node within Rack 336, Ethernet NIC 322 can convert the PCIe signals to Ethernet signals. Data in Ethernet signals is then transferred to TOR Switch 332 via Ethernet. TOR Switch 332 can transmit data to TOR Switch 334 via Ethernet.

According to some embodiments, PCIe Switch 338 can be configured to assign, for example, NIC 326 and NIC 328 to Node 312. For example, Node 312 may host a web application that handles large data transmission at peak hours from 9:00 a.m. to 5:00 p.m. To provide the corresponding networking capacity, Node 312 can be assigned two Ethernet NICs 326, 328 having two IP addresses at these peak time. On the other hand, another node that is inactive for network trafficking can share a NIC with another node.

According to some embodiments, the present technology can utilize a PCIe switch to provide flexible and dynamic network management. In addition to NICs, a PCIe switch can manage other PCIe devices such as Non-Volatile Memory Express (NVMe) controller or a storage card.

Furthermore, a service controller, e.g. a BMC, (not shown) can be used to configure the PCIe Switch 338. An administrator can use an administration device to connect to BMC for configuring PCIe Switch 338. For example, the administrator can assign NIC 326 and NIC 328 to Node 312. Other service controllers, e.g. a Rack Management Controller (RMC), (not shown) can be used to configure the PCIe switch as well.

According to some embodiments, when a PCIe backplane reaches its data transmission capacity, a PCIe bridge (not shown) can connect multiple PCIe backplanes to increase the capacity.

Additionally, other switching device that can provide high-speed data transmission and switching function can be utilized pursuant to disclosures of the present technology.

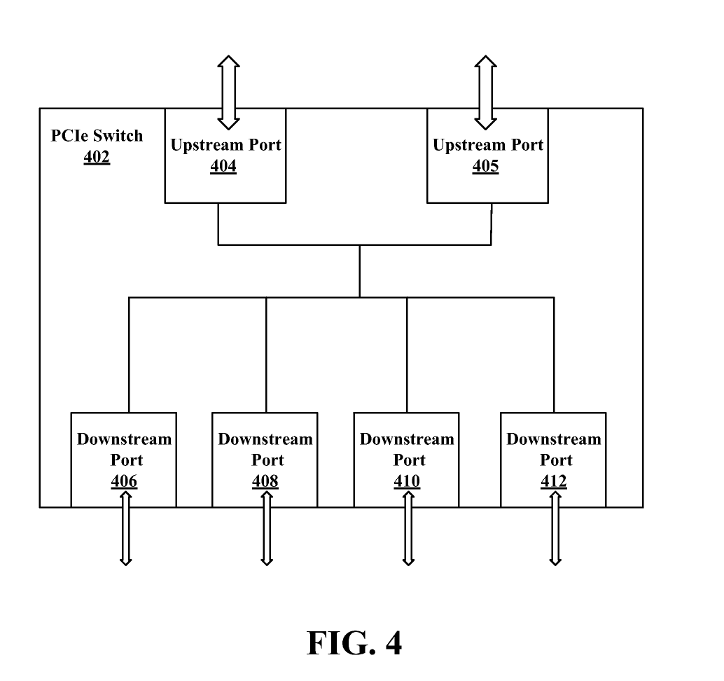

FIG. 4 is a schematic block diagram illustrating an example of a PCIe Switch 402, according to some embodiments. It should be appreciated that PCIe Switch 402 can comprise additional or fewer components, or various combinations of components, to the ones illustrated in the example of FIG. 4. For example, even not shown in FIG. 4, PCIe Switch 402 can comprise at least a switch controller, a memory, and a PCIe bridge. As illustrated in FIG. 4, PCIe Switch 402 can comprise multiple ports, including Upstream Port 404 and 405, Downstream Port 406, 408, 410 and 412.

According to some embodiments, PCIe switch 402 can be configured by a service controller to provide dynamic NIC assignment within a rack. For example, after determining an application executing on Node A (not pictured in FIG. 4) has higher data throughput than other nodes within the same rack, an administrator can configure PCIe Switch 402 to assign two or more NICs to Node A. Additionally, the administrator can configure PCIe Switch 402 to assign any NIC from a group of NICs (NIC pooling) to a specific node. According to some embodiments, other service controllers can be used to configure PCIe Switch 402. For example, a RMC can configure multiple PCIe switches housed in a rack.

Additionally, PCIe switch 402 can be coupled to other PCIe devices such as a NVMe controller that can expand the switch's functionality. For example, by utilizing NVMe, a node can be coupled to solid-state drives (SSDs) via PCIe.

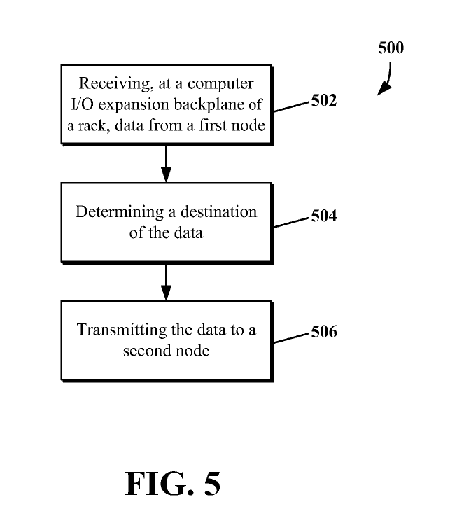

FIG. 5 is an example flow diagram for a PCIe high-bandwidth rack system 500, according to some embodiments. It should be understood that there can be additional, fewer, or alternative steps performed in similar or alternative orders, or in parallel, within the scope of the various embodiments unless otherwise stated.

At step 502, a computer I/O (Input/Output) expansion backplane of a first rack can receive data generated from a first node of the first rack. For example, the computer I/O expansion backplane can be a PICe backplane. According to some embodiments, the data can be in PCIe signals. According to some embodiments, other high-bandwidth low-latency I/O expansion backplanes can be coupled to the group of nodes.

At step 504, the system can determine a destination of the received data. According to some embodiments, the determination can be based on identifying control commands associated with the received data. For example, the PCIe backplane can identify an ID or an address of the destination from a packet.

At step 506, the system can transmit the data to a second node associated with the determined destination. According to some embodiments, when the determined destination is associated with a node within the same rack, e.g. intra-rack network trafficking, the system can transmit the data directly to the node within the same rack using PCIe protocol. According to some embodiments, PCIe protocol can enable high-speed data transmission for intra-rack network trafficking. According to some embodiments, when the second node is a node external to the present rack, e.g. inter-rack network trafficking, the system can transmit the data to a NIC associated with the PCIe backplane in PCIe signals. The NIC can convert the PCIe signals to Ethernet signals and transmit the data to an Ethernet switch, e.g. an integrated switch or a TOR switch. The integrated switch or the TOR switch can transmit the data to the other node located in another rack. Thus, by only using Ethernet NIC for inter-rack data transmission, the system can alleviate a bottleneck created by the Ethernet interface, which can improve system performance.

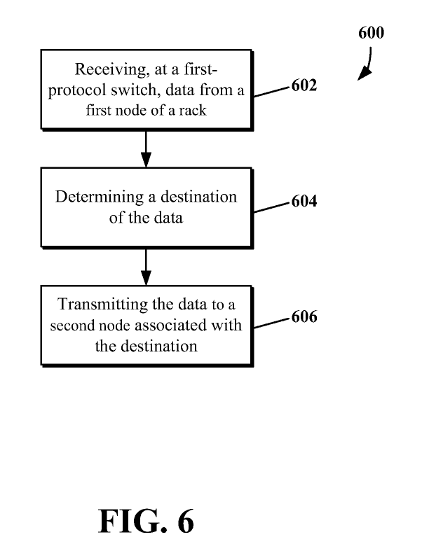

FIG. 6 is another example flow diagram for a PCIe high-bandwidth rack system 600 having a PCIe switch, according to some embodiments. It should be understood that there can be additional, fewer, or alternative steps performed in similar or alternative orders, or in parallel, within the scope of the various embodiments unless otherwise stated.

At step 602, a PCIe switch of a first rack can receive data generated from a first node in a rack. For example, a PCIe switch that is coupled to a PCIe backplane can be in communication with a group of NICs in a rack. According to some embodiments, other high-bandwidth low-latency switches can be coupled to the group of nodes. According to some embodiments, the PCIe switch can comprise, among other components, a switch controller, a memory, multiple ports and a NIC. The PCIe switch can provide dynamic NIC assignment to one or more nodes in the rack.

According to some embodiments, in addition to NICs, the PCIe switches can be coupled to other PCIe devices as well, which can provide flexibility and scalability to the computing system. Further, the PCIe switch can be configured by a service controller, e.g. BMC or RMC, for managing the connected PCIe devices.

At step 604, the system can determine a destination of the received data. According to some embodiments, the determination can be based on identifying control commands associated with the received data. For example, the PCIe switch can identify an ID or an address of the destination from a packet.

At step 606, the system can transmit the data to a second node associated with the determined destination. For example, when the determined destination is associated with a node within the same rack, the system can transmit the data directly to the node using a high-speed protocol. According to some embodiments, the high-speed protocol can be PCIe protocol. For example, when the determined destination is associated with a node outside the rack, the system can first transmit the data to a NIC of the originating node. After converting the PCIe signals to Ethernet signals, the NIC can transmit the data to an Ethernet switch, e.g. an integrated switch or a TOR switch. The integrated switch or the TOR switch can transmit the data to the other node located in another rack.

According to some embodiments, the NIC can transmit the data to a Rack Aggregation Switch that is in communication with more than one rack in a server network, via Ethernet or any other proper protocol.

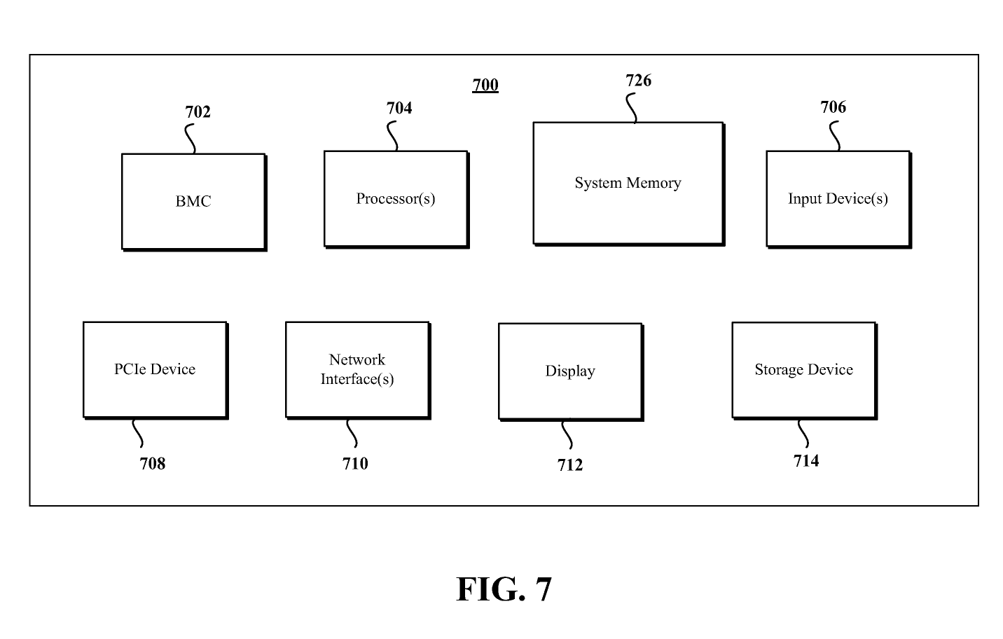

FIG. 7 illustrates an example system architecture 700 for implementing the systems and processes of FIGS. 1-6. Computing platform 700 includes one or more buses which interconnect subsystems and devices, such as: service controller 702, processor 704, storage device system memory 726, a network interface(s) 710, and a PCIe Device 708. Processor 704 can be implemented with one or more central processing units (“CPUs”), such as those manufactured by Intel® Corporation—or one or more virtual processors—as well as any combination of CPUs and virtual processors. Computing platform 700 exchanges data representing inputs and outputs via input-and-output devices input devices 706 and display 712, including, but not limited to: keyboards, mice, audio inputs (e.g., speech-to-text devices), user interfaces, displays, monitors, cursors, touch-sensitive displays, LCD or LED displays, and other I/O-related devices.

According to some examples, computing architecture 700 performs specific operations by processor 704, executing one or more sequences of one or more instructions stored in system memory 726. Computing platform 700 can be implemented as a server device or client device in a client-server arrangement, peer-to-peer arrangement, or as any mobile computing device, including smart phones and the like. Such instructions or data may be read into system memory 726 from another computer readable medium, such as storage device 714. In some examples, hard-wired circuitry may be used in place of or in combination with software instructions for implementation. Instructions may be embedded in software or firmware. The term “computer readable medium” refers to any tangible medium that participates in providing instructions to processor 704 for execution. Such a medium may take many forms, incl6uding, but not limited to, non-volatile media and volatile media. Non-volatile media includes, for example, optical or magnetic disks and the like. Volatile media includes dynamic memory, such as system memory 726.

Common forms of computer readable media includes, for example: floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read. Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, including wires that comprise bus 624 for transmitting a computer data signal.

In the example shown, system memory 726 can include various modules that include executable instructions to implement functionalities described herein. In the example shown, system memory 726 includes a log manager, a log buffer, or a log repository—each can be configured to provide one or more functions described herein.

Although the foregoing examples have been described in some detail for purposes of clarity of understanding, the above-described inventive techniques are not limited to the details provided. There are many alternative ways of implementing the above-described invention techniques. The disclosed examples are illustrative and not restrictive.

What is claimed is:

1. A method, comprising:
receiving, at a computer Input/Output (I/O) expansion backplane communicatively coupled to a plurality of nodes, data generated by a first node of the plurality of nodes;
determining a destination of the data based at least in part on information associated with the data; and
transmitting the data to a second node associated with the determined destination of the data,
wherein the computer expansion backplane is coupled to a plurality of Network Interface Controllers (NICs), each of the plurality of NICs being associated with one of the plurality of nodes.

2. The method of claim 1, wherein the computer I/O expansion backplane comprises a Peripheral Component Interconnect Express (PCIe) backplane.

3. The method of claim 2, wherein the second node is one of the plurality of nodes, and wherein the transmitting the data to the second node is based on a PCIe protocol.

4. The method of claim 1, wherein the second node is not one of the plurality of nodes, and wherein the transmitting the data to the second node is based on Ethernet protocol.

5. The method of claim 1, wherein the second node is not one of the plurality of nodes, and wherein the transmitting the data to the second node further comprises:
transmitting the data using Ethernet protocol to a NIC of the plurality of NICs, the NIC being associated with the first node.

6. The method of claim 5, wherein the transmitting the data to the second node further comprises:
transmitting the data using Ethernet protocol to a Top-of-Rack (TOR) switch, the TOR switch being communicatively coupled to the plurality of NICs.

7. The method of claim 5, wherein the transmitting the data to the second node further comprises:
converting the data to Ethernet signals using a NIC of the plurality of NICs, the NIC being associated with the first node.

8. A system, comprising:
a processor; and
a memory device including instructions that, when executed by the processor, cause the system to:
receive, at a first backplane associated with a first protocol and coupled to a plurality of nodes, data generated by a first node of the plurality of nodes;
determine a destination of the data based at least in part on information in a packet header associated with the data; and
transmit the data to a second node associated with the determined destination,
wherein the first backplane is coupled to a plurality of NICs associated with a second protocol, each of the plurality of NICs being associated with one of the plurality of nodes, and wherein the first protocol is operable to transmit data at a higher bandwidth than the second protocol.

9. The system of claim 8, wherein the second node is one of the plurality of nodes, and wherein the transmitting the data to a second node is based on the first protocol.

10. The system of claim 8, wherein the second node is not one of the plurality of nodes, and wherein the transmitting the data to a second node is based on the second protocol.

11. The system of claim 10, wherein the transmitting the data to a second node further comprises:
convert the data from the first protocol to the second protocol.

12. A method, comprising:
receiving, at a Peripheral Component Interconnect Express (PCIe) switch associated with a PCIe backplane, data generated by a first node of a plurality of nodes, the plurality of nodes being communicatively coupled to the PCIe backplane;
determining a destination of the data based at least in part on information in a packet header associated with the data; and
transmitting the data to a second node associated with the determined destination,
wherein the PCIe switch is associated with a plurality of NICs, and wherein the PCIe switch is operable to assign one or more of the plurality of NICs to one or more of the plurality of nodes.

13. The method of claim 12, wherein the second node is one of the plurality of nodes, and wherein the transmitting the data to a second node associated with the determined destination is based on PCIe protocol.

14. The method of claim 12, wherein the second node is not one of the plurality of nodes, and wherein the transmitting the data to a second node associated with the determined destination is based on Ethernet protocol.

15. The method of claim 14, further comprising:
converting the data transmission from PCIe signals to Ethernet signals using one or more NICs of the plurality of NICs associated with the first node.

16. The method of claim 14, further comprising:
transmitting the data to a TOR switch, the TOR switch being communicatively coupled to the PCIe switch.

17. The method of claim 12, wherein the PCIe switch is operable to be configured by a service controller in communication with the PCIe switch.

18. The method of claim 12, wherein the PCIe switch is operable to assign one or more NICs of the plurality of NICs to a node of the plurality of nodes.

19. The method of claim 12, wherein the PCIe switch is operable to assign a NIC of the plurality of NICs to one or more nodes of the plurality of nodes.

20. The method of claim 12, wherein the PCIe switch is operable to communicate with one or more PCIe devices.
